(19) United States
(12) Patent Application Publication
(10) Pub. No.: US 2005/0138079 A1
(43) Pub. Date: Jun. 23, 2005

(54) Processing, browsing and classifying an electronic document

(75) Inventors: Shi Xia Liu, Beijing (CN); Li Ping Yang, Beijing (CN)

Correspondence Address: IBM CORPORATION, T.J. WATSON RESEARCH CENTER, P.O. BOX 218, YORKTOWN HEIGHTS, NY, 10598, US

(73) Assignee: International Business Machines Corporation, Armonk, NY (US)

(21) Appl. No.: 11/012,674

(22) Filed: Dec. 15, 2004

(30) Foreign Application Priority Data
Dec. 17, 2003 (CN) 2003101231096

(51) Int. Cl. G06F 7/00

(52) U.S. Cl. 707/104.1

(57) ABSTRACT

Provides methods, apparatus, and systems for processing an electronic document and its corresponding device, a method for browsing an electronic document and its corresponding browser, and an electronic document classification and query method and its corresponding system for the same. The method for processing an electronic document comprises generating at least one category names to which the document belongs according to the content of said electronic document when being written by an author; and correspondingly storing said category name information with the electronic document. Wherein the category name(s) which the document belongs has passed the verification in order to ensure its reliability.

### FIELD OF THE INVENTION

The present invention relates to the technology of data processing, and more particularly to a method for processing electronic document and its corresponding device, a method for browsing electronic document and its corresponding browser, as well as a method for classifying and querying electronic document and the corresponding classifying and querying system, based on the technology of document classification.

### BACKGROUND DESCRIPTION

As the amount of information on Web increases exponentially, it becomes increasingly difficult to find information. How to quickly and effectively find needed resource and knowledge in the mass Web information resources is always a significant goal of information processing technology. In the process of information processing, performing document classification is always a challenging task. Normally, each portal, news web site, online shop or enterprise web site has its own categorization rules, categorization tree and content categorization structure, and it therefore has the requirement to classify a document to a specific category among the category structure. However, to perform document classification is always a complex task. Some sites classify the pages manually and some use the automatic categorization engines to do the job. The automatic categorization engines need a lot of training document for constructing the classifier, which is a time consuming process and needs the assistance of the domain expert.

Furthermore, in existing techniques, the electronic document writing tools are independent from the tools that users use to manage and categorize the documents. That is to say, the author neither cares which category the document will be classified to while he prepares it, nor cares how the future readers classify and query or use the content of the document written by the author in the future. But in the meantime, from the information accessing point of view, the user feels great challenge to get the right information he really wants in the needed category.

Further, since current technologies work mainly at the word level understanding, while the real world applications need sentence and document level understanding together with semantic capabilities. Therefore, as for the document management tools and document categorization tools, it needs sentence, even the understanding level of whole text of the document together with semantic capabilities. Because of the limitation of the related technique and tools, existing documents management and categorization technique will not be able to evolve the existing word level understanding to the sentence and whole document level understanding in short time. Therefore, it's believed that the development of document categorization technology will not be able to meet the requirements of the users' information accessing in next few years.

### SUMMARY OF THE INVENTION

Therefore, in order to solve the problem mentioned above in the existing document classifying techniques, the present invention provides that relevant information be prepared for future document classification, query and information retrieval when the author is writing the electronic documents, i.e., when the author is preparing the document, some tools are provided in order to contribute to user's convenient information retrieval. More specifically, when composing the document, he/she also prepares some classification information for document management, and then attaches the relevant information to the electronic document as knowledge tags. Thus help users retrieve the most relevant document in the specific category by using the attached classification information in the document conveniently and rapidly. Moreover, when reading the document that contains the classification information, one can retrieval the knowledge tag including the classification information and classify said document to one or more categories quickly. So the efficiency of the document classification is improved greatly. Also, because the author verifies said classification information, document classification can more accurately reflect the category to which the document should belongs.

According to one aspect of the present invention, an electronic document processing method is provided, comprising the steps of: generating one or more category names to which the document belongs according to the content of said electronic document when being written by an author; and correspondingly storing said category name information with the electronic document.

According to another aspect of the present invention, an electronic document processing device is provided, comprising: an electronic document editing unit for editing the electronic document; an electronic document classifying unit for classifying and analysis of said electronic document using various kind of classification methods, and generating a list of category name to which said document belongs based on the content of the electronic document; a category name storing unit for correspondingly storing the category name information to which the document belongs and is generated by electronic document classifying unit with the document.

Also provided are an electronic document browsing method, an electronic document browser, an electronic document classification and query method, and an electronic document classification and query system.

### BRIEF DESCRIPTION OF THE DRAWINGS

The above and other objects, features, and advantages of the present invention will become more apparent from the following detailed description when taken in conjunction with the accompanying drawings, in which:

FIG. 1 is a flowchart of electronic document processing method according to an embodiment of the present invention;

FIG. 2 is a schematic diagram showing the structure of an electronic document processing device according to an embodiment of the present invention;

FIG. 3 is a flowchart showing an electronic document browsing method according to an embodiment of the present invention;

FIG. 4 is a block schematic diagram showing the structure of an electronic document browser according to an embodiment of the present invention;

FIG. 5 is a flowchart showing an electronic document classification and query method according to an embodiment of the present invention; and

FIG. 6 is a block schematic diagram showing the structure of an electronic document classification and query system according to an embodiment of the present invention.

### DETAILED DESCRIPTION OF A PREFERRED EMBODIMENT OF THE INVENTION

The present invention provides methods, apparatus and systems wherein relevant information is prepared for future document classification, query and information retrieval when the author is writing the electronic documents, i.e., when the author is preparing the document, some tools are provided in order to contribute to user's convenient information retrieval. More specifically, when composing the document, he/she also prepares some classification information for document management, and then attaches the relevant information to the electronic document as knowledge tags. This helps users retrieve the most relevant document in the specific category by using the attached classification information in the document conveniently and rapidly. Moreover, when reading the document that contains the classification information, one can retrieval the knowledge tag including the classification information and classify said document to one or more categories quickly. So the efficiency of the document classification is improved greatly. Also, because the author verifies said classification information, document classification can more accurately reflect the category to which the document should belongs.

In an example embodiment of the present invention, an electronic document processing method is provided, comprising the steps of: generating one or more category names to which the document belongs according to the content of said electronic document when being written by an author; and correspondingly storing said category name information with the electronic document.

In another example embodiment of the present invention, an electronic document processing device is provided, comprising: an electronic document editing unit for editing the electronic document; an electronic document classifying unit for classifying and analysis of said electronic document using various kind of classification methods, and generating a list of category name to which said document belongs based on the content of the electronic document; a category name storing unit for correspondingly storing the category name information to which the document belongs and is generated by electronic document classifying unit with the document.

In another example embodiment of the present invention, an electronic document browsing method is provided, comprising the steps of: reading category name(s) to which the document belongs form the electronic document; presenting the user with the category name in the knowledge tag; and representing the content of said document to said user when the user confirms said category name.

In still another example embodiment of the present invention, an electronic document browser is provided, comprising: an electronic document browsing unit for browsing the content of the document; a category name retrieval unit for retrieving the category name to which the document belongs correspondingly stored with the document; a category name representation unit for representing said user the category name in the knowledge tag retrieved by category name retrieval unit.

In still another example embodiment of the present invention, an electronic document classification and query method is provided, comprising the steps of: extracting category name(s) to which the document belongs and correspondingly stored with the document; indexing the extracted category name information; searching from the index of the category names for one or more category names being the same or the closest to those input by the user in response to a query on a category name that the user is interested in; representing the user with one or more the same or the closest category names; providing the user with the electronic document or its link to the document corresponding to the category name selected by the user.

In still another example embodiment of the present invention, an electronic document classification and query system is provided, comprising: a category name extracting means for extracting category name (s) to which the document belongs and correspondingly stored with the electronic document; a category name indexing means for indexing the category name in the extracted category name information; a category name storing means for storing the index of category names produced by category name indexing means; a category name searching means for searching from the index of the category names one or more category names being the same with or the closest to the category name inputted by the user in response to a query on a category name that the user is interested in; a category name presentation means for representing the user with one or more category names searched by category name searching means; and an electronic document supply means for providing the user with the documents or their hyperlinks to the document corresponding to the category name selected by the user. Each advantageous embodiment of the invention is explained in detail below with reference to its corresponding drawing

Electronic Document Processing Method

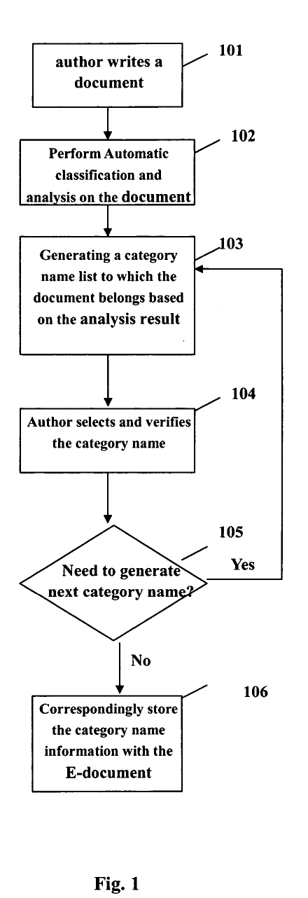

According to one aspect of the present invention, an electronic document processing method is provided. FIG. 1 is a flowchart of an electronic document processing method according to an embodiment of the present invention. As shown in FIG. 1, the author writes an electronic document in process 101. The electronic document processing method of the present invention is based on the traditional document editing method, that is, the writer performs routine operations such as editing, browsing, etc. on the electronic document being written using traditional document editing tools, such as MS Word□Adobe Writer or WPS, etc. According to the present invention, the category name information about the document being written by the author is generated when author has completed a document, or accomplished part of the document (such as a chapter).

Then, select the whole document (or part of the said document) to perform automatically classification analysis in process 102. This may employ document categorization methods available to perform the classification and analysis on the electronic document edited by the author. In process 102, according to one implementation of the present invention, various kinds of classification-tree can be used to automatically perform the automatic classification and analysis on the document using the following KNN method.

I) Pre-Processing the Text Information

Before extracting the feature from the electronic document, the text information should be preprocessed firstly. For example, it is necessary to extract the stem of the word for English language, but the Chinese language is different, that is because there's no required space symbol (blank space) between words in the Chinese language. Thus the segmentation process is needed. In the field of Chinese information processing, research on automatic segmentation have been attracted a lot of attentions. Some word segmentation methods have been proposed, such as maximum matching method, Association Backtracking method, minimum matching method and so on. After word segmentation, the stopwords should be removed from the document (Stopwords are those that are frequently used or those that should be excluded from the searching range such as found in a Chinese glossary).

II) Feature Presentation and Extraction

Feature presentation means presenting the document by some special feature items (e.g. term or characterization). The present invention adopts Vector Space Model (VSM), which is more popular in the applications. In VSM, text document is regard as a group of terms (t₁,t₂, . . . ,tₙ) in the present invention. Each term has a weight value wᵢ; therefore each document will be mapped as a vector in the vector space composed by a group of term vectors. Thus document matching can be transformed as the problem of vector matching in the vector space. There are a lot of methods for weighing the terms in the document. The most commonly used method is tf-idf method, as shown in formula (1),
wⱼ=tf*idf (1)

In formula (1), tf represents the frequency of the term occurred in the document, idf=all_documents/term_documents; here all_documents is the number of all documents; term_documents is the number of the document that contain the given terms.

The construction of the feature vector space determines the feature words for each category based on the foregoing method. And it calculates the weight for every feature word in this category. The feature vector space can be easily constructed by these messages. The number of the document category is supposed as M, the number of every category's keywords is N (there's no requirement for the same numbers of each category's keywords, for the sake of conveniently describing, it is supposes that the numbers of each category's keywords is the same). The method to construct the feature vector space is as follows:
(1) Utilizing every category's feature word tᵢ, calculate it's union to get a set of all feature words, W=(t₁, . . . , tᵢ, . . . ), the size of the set of feature words is |W|=MN, where 1≦i≦MN.
(2) Calculating its weight wᵢⱼ in other categories (M-1) for every feature word tᵢⱼ (i means the document of category i,j means the serial number of the feature word, tᵢⱼ means this feature word is the feature word j of category i). After calculating the weight of every feature word (totally |W| feature words) in every category Ci, then get a M×|W| weight matrix, where M is the number of rows, |W| is the number of columns.
(3) The M×|W| matrix gained from the vector normalized is the feature vector space of the text categorization.

III) Feature Matching and Document Classification

After gaining the feature word and feature vector space based on the foregoing training and statistical method, we can also gain the vector X of the feature word of every input document d by the same way. After calculating the distance (or call it similarity) between this vector X and every vector in the feature vector space, the text category to which the document belongs can be obtained based on the 1-nearest distance.

In process 103, in accordance with the result of document classification analyses, that is to say, when the category to which the document belongs has been determined, it can produce a list about the category name to which the document belongs.

It should be understood, the above illustration is just one of the methods that can generate the category name(s) to which the document belongs. The other methods for generating the category name(s) to which the document belongs can be selected as well.

Next, in process 104, according to the existing classification-tree and the training samples, the generated list of the category name to which the document belongs in the previous processes was verified. Therefore, “verification” includes author's viewing and modifying the generated category name, thus it is ensured that the category name can represent the category of the document exactly and entirely.

Moreover, in the analysis result of the document in process 102, the author can be provided with a reference document that is similar to the document written by the author, or the classification-tree utilized when classifying the reference document using different classification method. In this case, in process 104, it is also included: providing the reference document and the classification-tree used for classifying the reference document; allowing the author to compare the similarity between his/her written document and the reference document, and thereby verify the correctness of the generated category name to which the document belongs.

In succession, in process 105, it's determined that if more category names are expected to be generated for the document. Usually, a document may contain the content of many aspects and readers have different goals when searching and reading the documents. Therefore, if in process 105 it is determined that the document also contains more category names that can reflect the content of the document, the procedure will be back to the process 102 and the next category name will be generated according to the classification result of the document. If there is no other category names need to be generated, the procedure will go into the process 106.

In the process 106, the category name information that the document belongs to is correspondingly stored with the document. Specifically, according to the preferable embodiment of the present invention, the category name information can be stored correspondingly with electronic document as knowledge tags. For instance, extensible makeup language (XML) can be utilized to attach the tags to the document.

As mentioned above, the present invention doesn't limit the specific way by which the category name information is stored. For example, it can be stored with the electronic document as a part of the electronic document, and it can also be stored separately as long as it can correspond to the electronic document.

As will be apparent in the light of the foregoing disclosure of the above embodiment, when the electronic document processing method of the present embodiment is adopted, it becomes possible to assist the author complete several preparations for the category name to which the document belongs when the document is being prepared and ensure the correctness of the category name to which the document belongs by taking advantage of the writer's comprehension over said document without bringing additional workload to the writer. And, due to that multiple category names, which can fully reflect the category to which the document belongs, can be generated for this document, the document classification will be more exact and comprehensive when performing classification using website, thus higher user's satisfaction can be obtained.

Electronic Document Processing Device

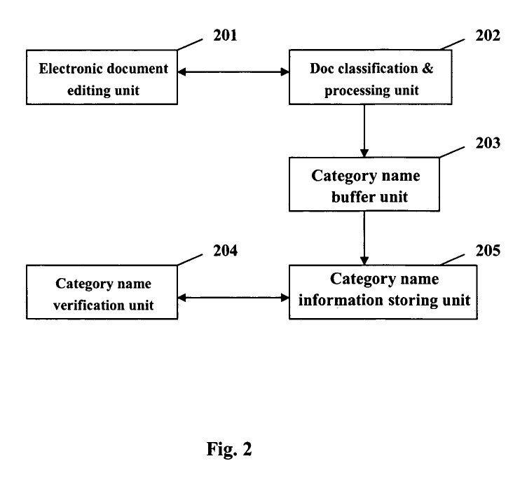

Under the same inventive concept, an electronic document processing device is provided according to one aspect of the invention. FIG. 2 is a schematic diagram showing the structure of an electronic document processing device according to an embodiment of the present invention.

As shown in FIG. 2, the electronic document processing device 200 includes: an electronic document editing unit 201 for editing the electronic document, wherein the electronic document editing unit 201 can either be an independent document editing unit or use the existing document editors, such as MS word, Adobe Writer or WPS, etc.; a document classifying unit 202, which is used for author to classify and analysis the electronic document written by the user using various kinds of classification methods, and generate a list of the category name(s) that the document belongs to; a category name buffer unit 203 which is used to temporarily store the category name information generated by document classifying unit 202; a category name verification unit 204, which is used to valuate and modify the category name(s) to which the document belongs and stored by the category name buffer unit 203 in order to determine the category name which the author's document belongs to; and the category name storing unit 206, which is used to correspondingly store the category name information generated by the document classifying unit 202 with the electronic document.

Furthermore, in the category name verification unit 204 of the document processing device 200 according to the present embodiment, for example, it may also include one more comparing unit (not shown). Then, the comparing unit provides one or more reference documents and the classification-tree of the reference document to be used to calculate the similarity between the document and the reference document. Then verifying whether the category name generated by the category name buffering unit 203 is correct or not.

As will be apparent in the light of the foregoing disclosure of the above embodiment, when the electronic document processing device of the present embodiment is adopted, it becomes possible to assist the author complete several preparations for the category name to which the document belongs when the document is being prepared and ensure the correctness of the category name to which the document belongs by taking advantage of the writer's comprehension over said document without bringing additional workload to the writer. And, due to that multiple category names, which can fully reflect the category to which the document belongs, can be generated for this document, the document classification will be more exact and comprehensive when performing classification using website, thus higher user's satisfaction can be obtained.

Electronic Document Browsing Method

Under the same inventive concept, an electronic document browsing method is provided according to another aspect of the present invention. Wherein the electronic document is the one generated by the electronic document processing method mentioned above, i.e., the category name(s) which the document belongs to, is correspondingly stored with the document.

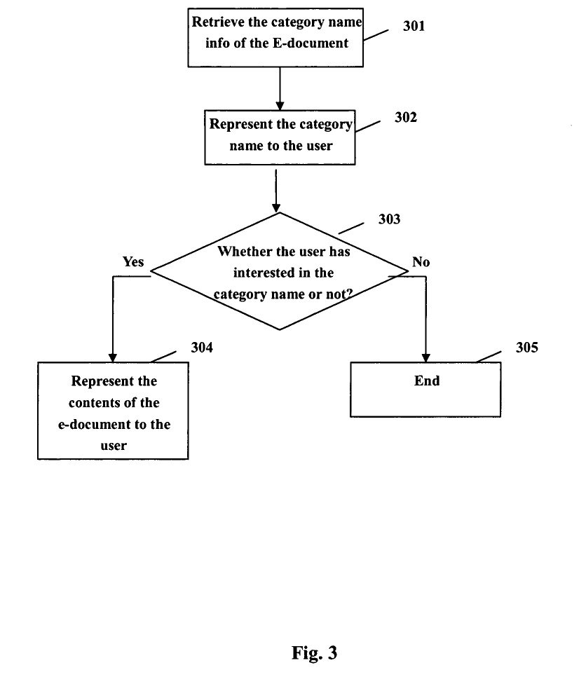

FIG. 3 is a flowchart showing an electronic document browsing method according to an embodiment of the present invention. As shown in FIG. 3, in process 301, firstly, the category name (s) that the document belongs to is retrieved from the electronic document. Specifically, the category name info is retrieved according to the way by which the information was stored. For example, if the category name info is stored at the end of the document as knowledge tags, the knowledge tags will be identified correspondingly and the category name info will be retrieved from it.

In succession, in process 302, the category name(s) will be presented to the user. Specifically, there are various kinds of method for presenting the category names. If the amount of the category names is large, user can input the category name that user expected to perform. Then select the category names that are most close to those of the category names input by the user and represent it to the user.

In succession, in process 303, the reader views the category name and judges that if he/she is interested in the document. If the user has interests in the document and makes a confirmation, then the procedure will enter into process 304, and the content will be represented to the reader. Otherwise, the document's content won't be shown and enter into the process 305 to end the process by closing the document.

From the description of the embodiment above, it can be known that if the electronic document browsing method of the present embodiment is adopted, the electronic document's category name info, which is generated by the electronic document processing method following the previous embodiment mentioned above, can be utilized. Before all contents are presented to the reader, the verified category name(s) to which the document belongs will be provided to the reader for viewing. Reader can thus understand approximate category of the document belongs to, thus the time of getting resource and knowledge can be saved for the reader.

Electronic Document Browser

Under the same inventive concept, an electronic document browser is provided according to one aspect of the invention. Wherein the electronic document is the one generated by the electronic document processing method mentioned above, i.e., the category name(s) which the document belongs to, is correspondingly stored with the document.

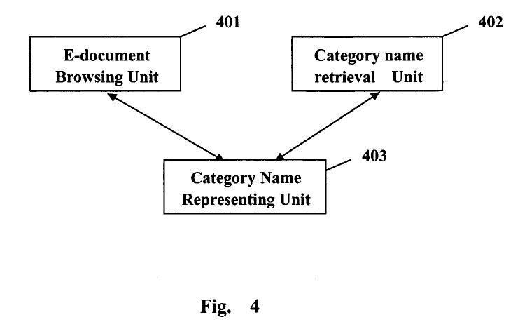

FIG. 4 is a block schematic diagram showing the structure of an electronic document browser according to an embodiment of the present invention. As shown in FIG. 4, the electronic document browser 400 includes: an electronic document browsing unit 401, which is used to browse the electronic document's content. It can be a browser using existing technologies such as MS Word Viewer, MS Internet Explorer, Netscape Navigator, Acrobat Reader, etc.;

A category name retrieval unit 402, which is used to retrieval the category name(s) correspondingly stored with the electronic document. Specifically, the category name(s) is retrieved according to the way it was stored. For instance, if the category name is stored at the end of the document as knowledge tags, the knowledge tags will be identified correspondingly and the category name info will be retrieved;

A category name info representing unit 403, which is used to represent the category name(s) retrieved by the category name retrieval unit 402 to the user. Specifically, there are various kinds of ways to represent the category name. For example, if the amount of the category names of the category that the document belongs to is large, user can input the category name that the user expected to perform. Then the category name, which is the same with or most close to the category name input by the user, will be selected from the category name list and the category name will be represent to the user. Under such circumstances, the browser 400 of the present embodiment can further include a category name selecting unit (not shown), which is used to select the category name that is the same or most close to the user's category name from the category names in the list of category name info.

From the description of the embodiment above, it can be known that the electronic document browser can implement the electronic document browsing method mentioned above. And if the electronic document browser of the present embodiment is adopted, the electronic document's category name info, which is generated by the electronic document processing method following the previous embodiment mentioned above, can be utilized. Before all contents are presented to the reader, the verified category name(s) that the document belongs to will be provided to the reader for viewing. Reader can understand approximate category of the document belongs to, thus the time of getting resource and knowledge can be saved for the reader.

Electronic Document Classification and Query Method

Under the same inventive concept, an electronic document classification and query method is provided according to another aspect of the present invention. Wherein the electronic document is the one generated by the electronic document processing method mentioned above, i.e., the category name(s) which the document belongs to, is correspondingly stored with the document.

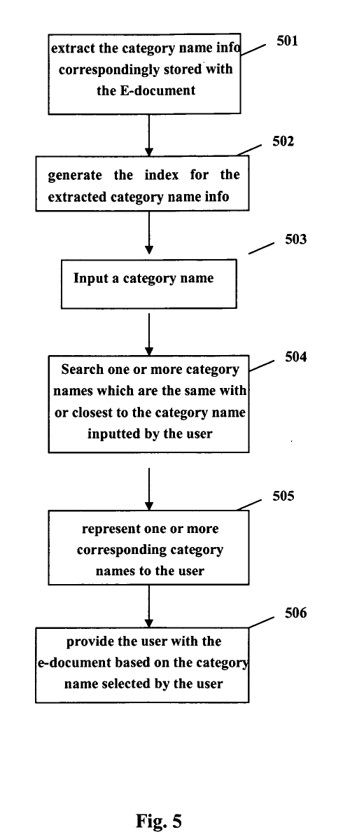

FIG. 5 is a flowchart showing an electronic document classification method according to an embodiment of the present invention. As shown in FIG. 5, in process 501, firstly, the category name(s) that the document belongs to is extracted, wherein the category name info being stored correspondingly with the electronic document. Specifically, if the author of the electronic document uses the electronic document processing device mentioned above to compose the document, each document may contain the info about the category name(s) to which the document belongs. In this process, the info about the category name(s) to which the document belongs will be extracted. Especially, for the electronic documents issued on the Internet, web crawler can be utilized to every electronic document all over the network and the corresponding category name info will be extracted, for instance, it is extracted from the knowledge tag.

In succession, in process 502, the indices are generated for the extracted category name info. Here, various kinds of retrieval methods in information retrieving field can be used to generate the indices for these category names, such as reverse order files, signature file, PAT tree, or PAT array, etc.

In succession, in process 503, the user input his/her own query of the category name.

In succession, in process 504, one or more category name, which are the same with or the closest to the category name inputted by the user, will be found out in the category name indices. Specifically, the method calculates the relevant degree between the user's category name and each category name in the category name indices, and the category name whose relevant degree is the highest or higher than a given value will be selected.

Then, in process 505, the category name that is the same with or closest to the user's category name will be represented to the user. And, in process 506, when user selects one of the category names, the use will be provided with the electronic document according to user's category name or a link to said document.

From the description of the embodiment above, it can be known that the electronic document classification and query method of present embodiment can utilize the electronic document's category name info that is generated by the electronic document processing method mentioned above. And, due to that multiple category names, which can fully reflect the category which the document belongs to, can be generated for this document, the document classification will be more exact and comprehensive when performing classification using website, info portal or intranet, thus higher user's satisfaction can be obtained. Due to that the category names have passed the verification, the veracity and readability of the category name can be guaranteed. As a result, the electronic document classification and query method in this embodiment is more accurate. Further more, before all category names are presented to the reader, the category name(s), which is verified by the user, will be provided to the reader for viewing. Reader can understand approximate category name of the category, thus the time of getting resource and knowledge can be saved for the reader.

Electronic Document Classification and Query System

Under the same inventive concept, an electronic document classification and query system is provided according to another aspect of the present invention. Wherein the electronic document is the one generated by the electronic document processing method mentioned above, i.e., the category name(s) which the document belongs to, is correspondingly stored with the document.

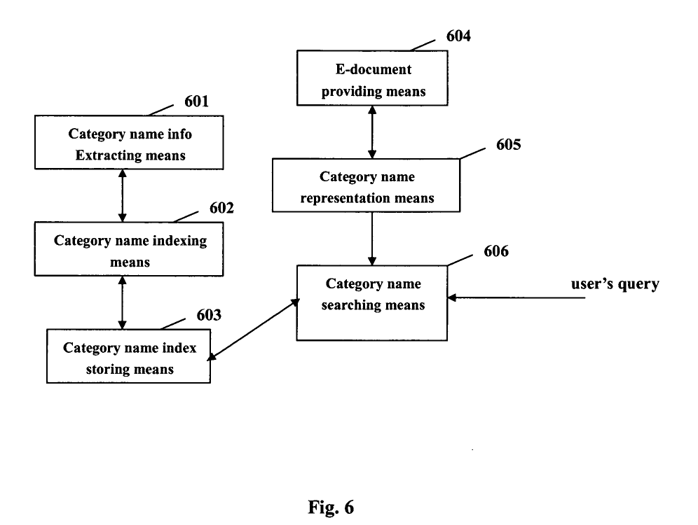

Corresponding to the classifying method illustrated in FIG. 5, FIG. 6 is a block schematic diagram showing the structure of an electronic document classification and query system according to an embodiment of the present invention. As shown in FIG. 6, electronic document classification and query system 600 includes: a category name info extractor 601, which is used to extract the category name info stored correspondingly with the electronic document, wherein as discussed above, category name info extractor 601 maybe a web crawler used to search every electronic document all over the network and extract the corresponding category name info; a category name index means 602 for indexing the extracted category names info; a category name index storing means 603 for storing the category name indices generated by category name index means 602; a category name searching means 606 for searching one or more category names being same with or closest to the user's category name inputted from the category name indices stored in the category name index storing means 603; a category name presentation means 605 for presenting the user with one or more category names which are the same with or closest to user's category name and searched by the category name searching means 606; and an electronic document supply means 604 for providing the user with the electronic document or its link to said document according to the user's selected category name.

Furthermore, the electronic document classification and query system 600 may further include: relevance calculating means (not shown) for calculating the similarity between two category names thereby the category name searching means 606 may utilize the relevance calculating means to calculate the relevance degree between category name input by the user and the category names in the category name indices and get out one category name with the highest relevance degree or the one whose relevance degree is larger than a given value.

From the description of the embodiment above, it can be known that the electronic document classification and query system of the present embodiment can be used in conjunction with the electronic document classification and query method illustrated in FIG. 5, generating multiple category names, which can fully reflect the category that the document belongs to for this document, the document classification will be more exact and comprehensive when performing classification using website, info portal or intranet, thus higher user's satisfaction can be obtained. Due to that the category names have passed the verification, the veracity and readability of the category name can be guaranteed. As a result, the electronic document classification and query system of the present embodiment is more accurate. Further more, before all category name of the category are presented to the reader, the category name, which is verified by the user, will be provided to the reader for viewing. The reader can understand approximate category name of the category, thus the time of getting resource and knowledge can be stored for the reader.

The method for processing an electronic document and its corresponding device, a method for browsing an electronic document and its corresponding browser, and an electronic document classification and query method are disclosed above through examples, but it should be noted that these embodiments are only exemplary examples, persons skilled in this technical field can make various alterations or modifications in implementing this invention without departing from the spirit or scope thereof. Therefore, the invention is not limited to these embodiments, and is only defined by the following claims.

Variations described for the present invention can be realized in any combination desirable for each particular application. Thus particular limitations, and/or embodiment enhancements described herein, which may have particular advantages to a particular application need not be used for all applications. Also, not all limitations need be implemented in methods, systems and/or apparatus including one or more concepts of the present invention.

The present invention can be realized in hardware, software, or a combination of hardware and software. A visualization tool according to the present invention can be realized in a centralized fashion in one computer system, or in a distributed fashion where different elements are spread across several interconnected computer systems. Any kind of computer system—or other apparatus adapted for carrying out the methods and/or functions described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

Thus the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

1. An electronic document processing method comprising the steps of:
generating at least one category names to which the electronic document belongs according to content of said electronic document when being written by an author; and
correspondingly storing said category name information with the electronic document.

2. The document processing method according to claim 1, wherein the step for generating at least one category names to which the document belongs comprises:
classifying the document using a plurality of classification methods and the corresponding classification-tree; and
generating at least one category names to which the document belongs according to the result of document classifying.

3. The electronic document processing method according to claim 2, wherein the step of classifying the document using a plurality of classification methods and the corresponding classification-tree further comprises:
i) performing pre-processing for word segmentation on said electronic document and removing the stopword;
ii) calculating the feature vector presentation for the preprocessed electronic document;
iii) matching the calculated feature vector and the feature vector of every category in the known classification tree obtained by using training and statistic method;
iv) determining the category to which the document belongs according to the matching degree.

4. The electronic document processing method according to claim 2, wherein the step of generating at least one category names to which the document belongs further comprises:
verifying the generated category name to which the document belongs through evaluation and modification.

5. The electronic document processing method according to claim 4, wherein the step of verifying the generated category name to which the document belongs to through evaluation and modification further comprises:
generating several reference documents using a plurality of classification methods, wherein the content of the reference document is similar to that of said document;
calculating the relevance degree between said verified category name of the category to which the document belongs and the category name of the category to which said reference document belongs;
calculating the reliability of said verified category name of the category to which said document belongs based on the calculated relevance degree.

6. The electronic document processing method according to claim 1, wherein the step of correspondingly storing said category name information with the electronic document further comprises:
storing said category name information with said electronic document as a knowledge tag.

7. The electronic document processing method according to claim 1, wherein the step of correspondingly storing said category name information with the electronic document further comprises:
storing said category name information as a knowledge tag file associated with said electronic document.

8. An electronic document processing device comprising:
an electronic document editing unit for editing the electronic document;
an electronic document classifying unit for classifying and analysis of said electronic document using various kinds of classification methods, and generating a list of category names of the category to which said document belongs based on the content of the electronic document;
a category name storing unit for correspondingly storing the category name(s) to which the document belongs and is generated by electronic document classifying unit with the document.

9. The electronic document processing device according to claim 8, further comprising
a category name buffer unit for temporarily storing the category name information generated by document classifying unit; and
a category name verifying unit for evaluating and modifying the category name information stored by category name buffer unit.

10. The electronic document processing device according to claim 9, further comprising a comparing unit for providing at least one reference documents and the classification-tree on said reference document so as to calculate the similarity between said document and the reference document, and then verifying whether the category name generated by the category name generating unit is correct.

11. An electronic document browsing method, comprising the steps of:
retrieving category name(s) to which the document belongs form the electronic document;
presenting the user with the category name; and
representing the content of the electronic document to said user when the user confirms said category name.

12. The electronic document browsing method according to claim 11, wherein the step of representing the content of the electronic document to said user further comprises:
selecting from the represented list of the category name being closest to those input by the user in response to a query on a category name that the user is interested in; and
representing the same or closest category name to the user.

13. An electronic document browser comprising:
an electronic document browsing unit for browsing the content of the document;
a category name information retrieving unit for retrieving the category name(s), to which the document belongs correspondingly, stored with the document; and
a category name representation unit for representing said user the category name in the category name information read by the category name information reading unit.

14. The electronic document browser according to claim 13, further comprising:
a category name selection unit for selecting the category name being the same with or closest to the user's input from said category names in response to a query on a category name that the user interested in; and
wherein the category name representation unit is only to represent the user with the same or the closest category name.

15. An electronic document classification and query method, comprising the steps of:
extracting category name(s) to which the document belongs and correspondingly stored with the document;
indexing the extracted category name information;
searching from the index of the category names for at least one category names being the same or the closest to those input by a user in response to a query on a category name that the user is interested in;
representing the user with at least one of a same or a closest category names; and
providing the user with the electronic document or its link to the document corresponding to the category name selected by the user.

16. The electronic document classification and query method according to claim 15, wherein the step of searching from the index of the category names for at least one category names being the same or the closest to those input by the user further comprises:
calculating the relevance degree between the category name input by the user and each category name in the index of category names; and
selecting the category names with the highest relevance degree or whose relevance degree is higher than a given value.

17. An electronic document classification and query system comprising:
a category name extracting means for extracting category name(s) to which the document belongs and correspondingly stored with the electronic document;
a category name indexing means for indexing the category name in the extracted category name information;
a category name storing means for storing the index of category names produced by category name indexing means;
a category name searching means for searching from the index of the category names at least one category names being the same with or the closest to the category name input by the user in response to a query on a category name that the user is interested in;
a category name presentation means for representing the user with at least one category names searched by category name searching means; and
an electronic document supply means for providing the user with the documents or their hyperlinks to the document corresponding to the category name selected by the user.

18. The electronic document classification and query system according to claim 17, further comprising:
a relevance calculating means for calculating the similarity between two category names;
wherein the category name searching means utilizes said relevance calculating means, for calculating the category name input by the user and the category name in the index of the category names, and for selecting one category name with the highest relevance degree or whose relevance degree is higher than a given value.

19. An article of manufacture comprising a computer usable medium having computer readable program code means embodied therein for causing electronic document processing, the computer readable program code means in said article of manufacture comprising computer readable program code means for causing a computer to effect the steps of claim 1.

20. A computer program product comprising a computer usable medium having computer readable program code means embodied therein for causing functions of an electronic document processing device, the computer readable program code means in said computer program product comprising computer readable program code means for causing a computer to effect the functions of claim 8.

21. An article of manufacture comprising a computer usable medium having computer readable program code means embodied therein for causing electronic document browsing, the computer readable program code means in said article of manufacture comprising computer readable program code means for causing a computer to effect the steps of claim 11.

22. An article of manufacture comprising a computer usable medium having computer readable program code means embodied therein for causing electronic document and query, the computer readable program code means in said article of manufacture comprising computer readable program code means for causing a computer to effect the steps of claim 15.

23. A computer program product comprising a computer usable medium having computer readable program code means embodied therein for causing functions of an electronic document and query system, the computer readable program code means in said computer program product comprising computer readable program code means for causing a computer to effect the functions of claim 17.
